(19) United States
(12) Patent Application Publication
(10) Pub. No.: US 2023/0192918 A1
(43) Pub. Date: Jun. 22, 2023

(54) PROCESS FOR POLYMERIZING AT LEAST ONE RADICALLY POLYMERIZABLE COMPOUND

(71) Applicants: BOSTIK SA, Colombes (FR); CENTRE NATIONAL DE LA RECHERCHE SCIENTIFIQUE, Paris (FR); UNIVERSITE DE BORDEAUX, BORDEAUX (FR); INSTITUT POLYTECHNIQUE DE BORDEAUX, TALENCE CEDEX (FR)

(72) Inventors: Marine DELGADO, VENETTE (FR); Guillaume MICHAUD, VENETTE (FR); Boris COLIN, VENETTE (FR); Frédéric SIMON, VENETTE (FR); Stéphane FOUQUAY, COLOMBES (FR); Mathieu PUCHEAULT, TALENCE CEDEX (FR)

(21) Appl. No.: 17/996,121

(22) PCT Filed: Apr. 7, 2021
(86) PCT No.: PCT/FR2021/050612

§ 371 Date: Oct. 13, 2022

(30) Foreign Application Priority Data
Apr. 16, 2020 (FR) FR2003811

(51) Int. Cl. C08F 120/14; C08F 112/08

(52) U.S. Cl. CPC C08F 120/14; C08F 112/08

(57) ABSTRACT

The present invention relates to a process for polymerizing at least one radically polymerizable compound comprising at least one ethylenic bond, in the presence of a borane BH₃-amine complex and an alkene.

### FIELD OF THE INVENTION

The present invention relates to a process for polymerizing at least one radically polymerizable compound comprising at least one ethylenic bond, in the presence of a borane BH₃-amine complex and an alkene.

### TECHNICAL BACKGROUND

Radical polymerization constitutes one of the industrially most exploited polymerization processes due to the variety of polymerizable monomers, its ease of implementation and the variety of synthesis processes employed (bulk, emulsion, solution, suspension).

The use of organoboranes for the radical polymerization of compounds comprising an ethylenic bond is known in the prior art. However, due to the unstable and pyrophoric nature of organoboranes, they must be complexed with an amine in order to avoid oxidative decomposition. In some cases, despite complexing the organoborane with the amine, since the organoborane-amine complexes are highly reactive, this continues to present risks related to their handling and to the safety of operations.

Generally, before the initiation of the polymerization, the presence of a compound such as an oxidizing agent (such as a peroxide) is necessary for the initiation of the polymerization. However, these types of compounds are very reactive as well, which can make their use during the polymerization dangerous.

Document U.S. Pat. No. 2,973,337 describes the polymerization of unsaturated compounds comprising one or more ethylenic bonds, using catalysts of borazane type.

Document U.S. Pat. No. 6,632,908 relates to (meth)acrylic compositions used for the adhesion of metal, plastic or glass substrates to substrates of the same nature or of a different nature, such as substrates having a low-energy surface. The (meth)acrylic compositions described in this document comprise a (meth)acrylate compound and an initiator system comprising an organometallic compound, a peroxide compound, an aziridine-based compound and a compound having an acid function.

Document U.S. Pat. No. 3,236,823 describes the polymerization of unsaturated compounds comprising one or more ethylenic bonds, using organoborane-amine complexes.

There is therefore a real need to provide a process for efficiently polymerizing a radically polymerizable compound, with it being possible for the compound used for the polymerization to be used safely by avoiding the use of dangerous reagents. There is therefore a real need to provide a polymerization process that does not present problems of migration of reagents or of the compounds obtained. There is therefore a real need to provide a polymerization process that does not have the drawbacks associated with the use of certain initiators, for example peroxide initiators which exhibit oxygen inhibition, initiators of the organoborane-amine complex type which are pyrophoric and which require the presence of a decomplexing agent such as an isocyanate or succinic anhydride compound.

### SUMMARY OF THE INVENTION

The invention firstly relates to a process for polymerizing at least one radically polymerizable compound comprising at least one ethylenic bond, comprising the following steps:

bringing a borane BH₃-amine complex into contact with an alkene compound so as to obtain a reaction medium; and

bringing a composition comprising the at least one radically polymerizable compound comprising at least one ethylenic bond into contact with the reaction medium obtained;

said alkene compound being chosen from:

-1- an alkene compound of general formula [Chem 1]

H₂C=CH—R¹¹

R¹¹ representing a group comprising from 3 to 31 carbon atoms chosen from a linear or branched alkyl group, an arylalkyl group, a cycloalkyl group, an —OR¹² group, an —SR¹² group and an —SiR¹³R¹⁴R¹⁵ group;

R¹² being chosen from a linear or branched alkyl group, an arylalkyl group, a cycloalkyl group, an acyl group or a —COR¹⁶ group;

R¹³, R¹⁴, R¹⁵ being chosen, independently of one another, from a linear or branched alkyl group, an aryl group, a cycloalkyl group or an alkoxy group;

-2- an alkylene compound of general formula [Chem 2]

H₂C=CH—CH₂—R₁₁

R₁₁ representing a group comprising from 3 to 31 carbon atoms chosen from a linear or branched alkyl group, an arylalkyl group, a cycloalkyl group, an —OR¹² group, an —SR¹² group and an —SiR¹³R¹⁴R¹⁵ group;

R¹² being chosen from a linear or branched alkyl group, an arylalkyl group, a cycloalkyl group or an acyl group;

R¹³, R¹⁴, R¹⁵ being chosen, independently of one another, from a linear or branched alkyl group, an aryl group, a cycloalkyl group or an alkoxy group; and/or

3- an alkene compound of general formula

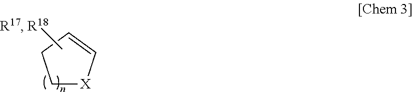

X being an oxygen atom, a sulfur atom or a bridge-forming —CH₂— divalent radical,

n being an integer from 2 to 10; and

R¹⁷ and R¹⁸ representing, independently of one another, a hydrogen atom, a linear or branched alkyl group comprising from 1 to 10 carbon atoms, a linear or branched alkene group comprising from 1 to 10 carbon atoms or a —CH₂—divalent radical forming a bridge with the ring.

In some embodiments, the amine is chosen from diisopropylamine, N-methyldiisopropylamine, N-ethyldiisopropylamine, dicyclohexylamine, N-methyldicyclohexylamine, N-ethyldicyclohexylamine, di-sec-butylamine, di-tert-butylamine, 1,1,,3,3,3-hexamethyldisilazane, N-methyl-1,1,1,3,3,3-hexamethyldisilazane, N-ethyl-1,1,1,3,3,3-hexamethyldisilazane, 2,6-dimethylpiperidine, N-methyl-2,6-dimethylpiperidine, N-ethyl-2,6-dimethylpiperidine, 7-azabicyclo[2.2. 1]heptane, N-ethyl-7-azabicyclo[2.2.1]heptane, 1-azabicyclo[2.2.2]octane and combinations thereof.

In some embodiments, the radically polymerizable compound is chosen from a styrene monomer, an acrylic monomer, a methacrylic monomer and combinations thereof; preferentially, the radically polymerizable compound is chosen from an acrylate, an acrylic acid, an acrylamide, an acrylonitrile, a methacrylate, a methacrylic acid, a methacrylamide, a methacrylonitrile and combinations thereof.

In some embodiments, the alkene compound is chosen from decene, octene, allyltrimethylsilane, tert-butyl vinyl ether, 4-bromo-1-butene, vinyltrimethoxysilane and vinyltriethoxysilane.

In some embodiments, the borane BH₃-amine complex and the alkene compound are added with a molar ratio of from 1:1 to 1:20 and preferentially from 1:3 to 1:10.

In some embodiments, the radically polymerizable compound has a content by mass of from 10% to 99%, preferentially from 30% to 95%, relative to the composition.

In some embodiments, said process is carried out in the absence of agents for decomplexing the borane and the amine, preferentially in the absence of isocyanate compounds.

In some embodiments, said process further comprises a heating step after bringing the borane BH₃-amine complex into contact with the alkene compound; preferentially a heating step carried out at a temperature of from 20 to 60° C., very preferentially from 35 to 55° C.

In some embodiments, the process further comprises a heating step after bringing the reaction medium into contact with the composition comprising at least one polymerizable compound; preferentially, a heating step is carried out at a temperature of from 20 to 100° C., very preferentially from 35 to 85° C.

The present invention meets the need expressed above. It provides more particularly a process for efficiently polymerizing a radically polymerizable compound, with it being possible for the compound used for the polymerization to be used safely by avoiding the use of dangerous reagents. This is accomplished through a process which comprises bringing a composition comprising a borane-amine (that is to say BH₃-amine) complex into contact with an alkene compound so as to obtain a reaction medium and then bringing the reaction medium obtained into contact with at least one radically polymerizable compound comprising at least one ethylenic bond. The composition comprising the borane-amine complex and the alkene compound makes it possible to avoid the use of pyrophoric and unstable commercial organoborane complexes. In addition, since the borane-amine complexes are more stable and less reactive than the organoborane-amine complexes, this makes it possible to better control the reactivity of the polymerizable composition and to limit the risks associated with the safety of the processes. In addition, the borane-amine complex is more stable and less pyrophoric than the commercial organoborane-amine complexes, thereby making it possible to better control the reactivity of the polymerizable composition and to limit the risks associated with the safety of the processes, and the handling of dangerous products is limited. In addition, the process according to the invention also allows the polymerization of monomers comprising an ethylenic bond without the use of reactive compounds such as decomplexing agents conventionally used to decomplex the borane (BH₃) and the amine. This makes it possible to facilitate and simplify the polymerization process.

The polymerization process according to the present invention allows the rapid and efficient polymerization of polymerizable compounds.

### DETAILED DESCRIPTION

The invention is now described in greater detail and in a nonlimiting manner in the description that follows.

### Borane-Amine Complex

The term “borane”, or “trihydridoboron” according to systematic nomenclature, is understood to mean a molecule having the formula “BH₃”.

Since borane is a highly reactive molecule, its complexation with an amine is necessary in order to ensure good storage of the borane.

The amine may be a monoamine (comprising a single amine group) or a polyamine (comprising more than one amine group, for example two, three or four amine groups). In the case of polyamines comprising a main chain, the amine groups may be present at the ends of the main chain and/or in the form of side or pendant groups along the main chain.

Preferably, the amine is a monoamine.

When the amine is a monoamine, it may be chosen from a primary, secondary or tertiary monoamine. According to certain embodiments, the monoamine can be of general formula

[Chem 4]

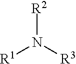

R¹, R² and R³ representing, independently of one another, a hydrogen atom, a silyl group, a group comprising from 1 to 20 carbon atoms, optionally comprising one or more heteroatoms chosen from oxygen, sulfur and nitrogen, the group being linear or branched and saturated or unsaturated and being chosen from an alkyl group, a cycloalkyl group, an arylalkyl group or an aryl group, or at least two of R¹, R² and R³ forming part of a cycloalkyl group. By way of example, R¹, R² and R³ may independently be a methyl group, an ethyl group, an n-propyl group, an isopropyl group, an n-butyl group, an isobutyl group, a sec-butyl group, a tert-butyl group, a cyclopropyl group, a cyclobutyl group, a cyclopentyl group, a cyclohexyl group, a benzyl group, a phenyl group which is substituted or not by one or more groups such as an alkyl (alkylaryl) or cycloalkyl group, an alkoxy group, a halogen, a nitro group, and an acyl group, a naphthyl group which is substituted or not by one or more groups such as an alkyl or cycloalkyl group, an alkoxy group, a halogen, a nitro group, and an acyl group, a heteroaryl group which is substituted or not by one or more groups such as an alkyl or cycloalkyl group, an alkoxy group, a halogen, a nitro group, and an acyl group. As examples of heteroaryl groups, mention may be made of pyridines, pyrroles and carbazoles. Alternatively, two of R¹, R² and R³ may form part of a ring, for example of a pyrrolidine, of a piperidine, of a morpholine, of a thiomorpholine, or of one of the higher homologs thereof.

Still alternatively, at least two of R¹, R² and R³ may form part of several rings such as for example 1-azabicyclo[2.2.2]octane (or quinuclidine), 1,4-diazabicyclo[2.2.2]octane (or DABCO) and 7-azabicyclo[2.2.1]heptane.

According to certain embodiments, R¹, R² and R³ may independently be chosen from a silyl group. For example, this silyl group may comprise a silicon atom substituted by three carbon-based groups having from 1 to 10 carbon atoms, preferably from 1 to 5 carbon atoms and more preferably from 1 to 3 carbon atoms, and is linear or branched. These three groups can be independently chosen from an alkyl group, a cycloalkyl group, an arylalkyl group and an aryl group. Preferably, they are an alkyl group and even more preferably a methyl group.

Furthermore, according to certain embodiments, two of R¹, R² and R³ may be alkyl groups and the third of R¹, R² and R³ may be a hydrogen atom. One example of this type is 1,1,1,3,3,3-hexamethyldisilazane (or HMDS).

According to certain embodiments, R¹, R² and R³ may be identical.

According to other embodiments, R¹, R² and R³ may be different from one another.

According to certain embodiments, at least two of R¹, R² and R³ are identical.

According to certain embodiments, at least one of R¹, R² and R³ is a hydrogen.

According to other embodiments, none of R¹, R² and R³ is a hydrogen.

According to preferred embodiments, when the monoamine of formula [Chem 4] is a primary amine, it may be tert-butylamine.

According to preferred embodiments, when the monoamine of formula [Chem 4] is a secondary amine, it may be diisopropylamine, dicyclohexylamine, di-sec-butylamine, diisobutylamine, di-tert-butylamine, 1,1,1,3,3,3-hexamethyldisilazane, 2,6-dimethylpiperidine or 7-azabicyclo[2.2.1]heptane, and preferably diisopropylamine.

According to preferred embodiments, when the monoamine of formula [Chem 4] is a tertiary amine, it may be N-methyldiisopropylamine, N-ethyldiisopropylamine, N-methyldicyclohexylamine, N-ethyldicyclohexylamine, N-methyl-2,6-dimethylpiperidine, N-ethyl-2,6-dimethylpiperidine, 1-azabicyclo[2.2.2]octane (or quinuclidine), N-methyl-1,1,1,3,3,3-hexamethyldisilazane, N-ethyl-1,1,1,3,3,3-hexamethyldisilazane, N-methyl-7-azabicyclo[2.2.1]heptane or N-ethyl-7-azabicyclo[2.2.1]heptane.

More preferably, it may be N-methyldiisopropylamine, N-ethyldiisopropylamine, N-methyldicyclohexylamine, N-ethyldicyclohexylamine, or N-methyl-2,6-dimethylpiperidine.

According to other embodiments, the monoamine may be a polyetheramine, i.e. an amine comprising multiple ether functions.

According to preferred embodiments, the monoamine is a primary polyetheramine.

According to other embodiments, the monoamine is a secondary or tertiary polyetheramine.

Thus, in the case where it is a monoamine which is a polyetheramine, it may be of general formula [Chem 5]

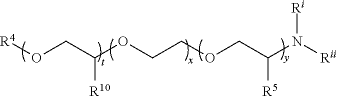

R⁴, R⁵ and R¹⁰ representing, independently of one another, a hydrogen atom or a group comprising from 1 to 10 carbon atoms, which is linear or branched, saturated or unsaturated and is chosen from an alkyl group, a cycloalkyl group, an arylalkyl group or an aryl group; Rⁱ and Rⁱⁱ representing, independently of one another, a hydrogen atom or a group comprising from 1 to 20 carbon atoms, which is linear or branched, saturated or unsaturated and is chosen from an alkyl group, a cycloalkyl group, an aryl group or an arylalkyl group;

t, x and y representing, independently of one another, an integer from 0 to 90, preferentially from 0 to 70, very preferentially from 0 to 50, more preferentially from 0 to 30;

R⁴, R⁵ and R¹⁰ may independently represent a hydrogen atom and a group comprising from 1 to 10 carbon atoms. This group may be linear or branched, saturated or unsaturated. Preferably, R⁴, R⁵ and R¹⁰ independently represent a linear or branched group comprising from 1 to 10 carbon atoms, preferably from 1 to 7 and more preferably from 1 to 3 carbon atoms.

According to certain embodiments, R⁴ may be chosen from an alkyl group, a cycloalkyl group, an arylalkyl group, an aryl group, or an alkylaryl group, the alkyl, cycloalkyl, arylalkyl, aryl and alkylaryl groups being as described above.

Preferably, R⁴ is an alkyl group, preferably comprising from 1 to 7 carbon atoms, and preferably from 1 to 3 carbon atoms.

According to certain embodiments, R⁵ may be chosen from an alkyl group, a cycloalkyl group, or an aryl group, these groups being as described above. Preferably, R⁵ is an alkyl group, in particular a group comprising from 1 to 2 carbon atoms. More preferably, R⁵ is chosen from a methyl group and an ethyl group.

According to certain embodiments, R¹⁰ may be chosen from an alkyl group, a cycloalkyl group, or an aryl group, the alkyl, cycloalkyl and aryl groups being as described above. Preferably, R¹⁰ is an alkyl group, in particular a group comprising from 1 to 2 carbon atoms. More preferably, R¹⁰ is chosen from a methyl group and an ethyl group.

According to certain preferred embodiments, R⁴, R⁵ and R¹⁰ may be identical.

According to other embodiments, R⁴, R⁵ and R¹⁰ may be different from one another.

According to preferred embodiments, R⁵ and R¹⁰ are different from one another. For example, one of R⁵ and R¹⁰ may be an ethyl group and the other of R⁵ and R¹⁰ may be a methyl group.

According to preferred embodiments, at least one of R⁴, R⁵ and R¹⁰ is a methyl group.

Rⁱ and Rⁱⁱ may independently represent a hydrogen atom or a group comprising from 1 to 20 carbon atoms. This group may be linear or branched, saturated or unsaturated.

According to certain embodiments, Rⁱ and Rⁱⁱ may independently be chosen from an alkyl group, a cycloalkyl group, an aryl group, or an arylalkyl group. By way of example, Rⁱ and Rⁱⁱ may independently be a methyl group, an ethyl group, an n-propyl group, an isopropyl group, a cyclopropyl group, a tert-butyl group, an isobutyl group, an n-butyl group, a sec-butyl group, a cyclobutyl group, a cyclopentyl group, a cyclohexyl group, an alkyl group substituted by an aryl group such as an alkyl phenyl, a phenyl group which is substituted or not by one or more groups such as an alkyl or cycloalkyl group, an alkoxy group, a halogen, a nitro group, and a carbonyl group, a naphthyl group which is substituted or not by one or more groups such as an alkyl or cycloalkyl group, an alkoxy group, a halogen, a nitro group, and a carbonyl group, a heteroaryl group which is substituted or not by one or more groups such as an alkyl or cycloalkyl group, an alkoxy group, a halogen, a nitro group, and an acyl group. As examples of heteroaryl groups, mention may be made of pyridines, pyrroles and carbazoles. Alternatively, Rⁱ and Rⁱⁱ may form part of a ring, for example of a pyrrolidine, of a piperidine, of a morpholine, of a thiomorpholine, or of one of the higher homologs thereof.

According to certain preferred embodiments, Rⁱ and Rⁱⁱ are both hydrogen atoms. In this case, it is a primary polyetheramine.

According to other embodiments, at least one of Rⁱ and Rⁱⁱ is a group comprising from 1 to 20 carbon atoms. In this case, it is a secondary polyetheramine.

According to other embodiments, both of Rⁱ and Rⁱⁱ are independently groups comprising from 1 to 20 carbon atoms. In this case, it is a tertiary polyetheramine.

According to certain embodiments, t, x and y may independently represent a number from 0 to 90, preferentially from 0 to 70, preferentially from 0 to 50, and even more preferentially from 0 to 30. Thus, t, x and y may independently represent a number from 0 to 10, or from 10 to 20; or from 20 to 30; or from 30 to 40; or from 40 to 50; or from 50 to 60; or from 60 to 70; or from 70 to 80; or from 80 to 90.

When t is other than 0, the number t represents the number of ethoxy groups substituted by a group R¹⁰ (preferably propoxy groups when R¹⁰ is methyl or butoxy groups when R¹⁰ is ethyl) present in the monoamine of formula [Chem 5].

The number t may or may not be an integer. For example, if a mixture of different alkylene oxides is used, t corresponds to the average degree of ethoxylation of the ethoxy groups substituted by a group R¹⁰ (preferably to the average degree of propoxylation when R¹⁰ is methyl or butoxylation when R¹⁰ is ethyl).

When x is other than 0, the number x represents the number of ethoxy groups present in the monoamine of formula [Chem 5].

The number x may or may not be an integer. For example, if a mixture of different alkylene oxides is used, x corresponds to the average degree of ethoxylation.

When y is other than 0, the number y represents the number of ethoxy groups substituted by a group R⁵ (preferably propoxy groups when R⁵ is methyl or butoxy groups when R⁵ is ethyl) present in the monoamine of formula [Chem 5].

The number y may or may not be an integer. For example, if a mixture of different alkylene oxides is used, y corresponds to the average degree of ethoxylation of the ethoxy groups substituted by a group R⁵ (preferably to the average degree of propoxylation when R⁵ is methyl or butoxylation when R⁵ is ethyl).

When t and y are other than 0, the sum t+y represents the number of ethoxy groups substituted by groups R⁵ and R¹⁰ (preferably propoxy groups when R⁵ and R¹⁰ are methyl or butoxy groups when R⁵ and R¹⁰ are ethyl) present in the amine of formula [Chem 5].

According to certain embodiments, when t is equal to 0, y is other than 0.

According to other embodiments, when y is equal to 0, t is other than 0.

According to yet other embodiments, in particular when R⁵ and R¹⁰ are different, t and y are both other than 0.

According to certain embodiments, when y and/or t is equal to 0, x is other than 0.

According to other embodiments, when x is equal to 0, y and/or t is other than 0.

The monoamines of formula [Chem 5] may have a molecular weight of 200 to 5500 g/mol, and preferably of 500 to 2500 g/mol. For example, the monoamines of formula [Chem 5] may have a molecular weight of 200 to 500 g/mol; or of 500 to 750 g/mol; or of 750 to 1000 g/mol; or of 1000 to 1250 g/mol; or of 1250 to 1500 g/mol; or of 1500 to 1750 g/mol; or of 1750 to 2000 g/mol; or of 2000 to 2250 g/mol; or of 2250 to 2500 g/mol; or of 2500 to 2750 g/mol; or of 2750 to 3000 g/mol; or of 3000 to 3250 g/mol; or of 3250 to 3500 g/mol; or of 3500 to 3750 g/mol; or of 3750 to 4000 g/mol; or of 4000 to 4250 g/mol; or of 4250 to 4500 g/mol; or of 4500 to 4750 g/mol; or of 4750 to 5000 g/mol; or of 5000 to 5250 g/mol; or of 5250 to 5500 g/mol. This type of polyetheramines is for example sold under the name Jeffamine M series by Huntsman.

When the amine is a polyamine, it may be chosen from a primary and/or secondary and/or tertiary polyamine. Preferably, it is a primary polyamine, i.e. all of its amine groups are primary amine groups. More preferably, it is a diamine. However, polyamines comprising more than two amine groups (for example three or four) such as polyethyleneimines (PEls) may be used. According to certain embodiments, the polyamine can be of general formula

[Chem 6]:

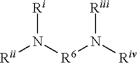

R⁶ representing a divalent group comprising from 2 to 60 carbon atoms, preferentially from 2 to 40 carbon atoms, optionally comprising one or more heteroatoms chosen from oxygen and sulfur, the group being linear or branched, saturated or unsaturated, and being chosen from a divalent alkyl radical, a divalent cycloalkyl radical, a divalent arylalkyl radical or a divalent aryl radical;

Rⁱ, Rⁱⁱ Rⁱⁱⁱ and R^{iv} representing, independently of one another, a hydrogen atom or a group comprising from 1 to 20 carbon atoms, which is linear or branched, saturated or unsaturated, and is chosen from an alkyl group, a cycloalkyl group, an aryl group or an arylalkyl group.

R⁶ may represent a divalent group comprising from 2 to 60 carbon atoms, preferably from 2 to 40 carbon atoms and more preferably from 2 to 15 carbon atoms.

R⁶ may be linear or branched, cyclic or alicyclic, saturated or unsaturated.

R⁶ may comprise one or more heteroatoms such as an oxygen atom, a sulfur atom, a nitrogen atom or a halogen. Preferably, a single heteroatom may be present in R⁶.

In addition, R⁶ may be chosen from a divalent alkyl radical, a divalent cycloalkyl radical, a divalent alicyclic radical, a divalent arylalkyl radical or a divalent aryl radical. Preferably, R⁶ is an alkyl group. Rⁱ and Rⁱⁱ are as detailed above.

Rⁱⁱⁱ and R^{iv} may independently represent a hydrogen atom or a group comprising from 1 to 20 carbon atoms. This group may be linear or branched, saturated or unsaturated.

According to certain embodiments, Rⁱⁱⁱ and R^{iv} may independently be chosen from an alkyl group, a cycloalkyl group, an aryl group, or an arylalkyl group.

By way of example, Rⁱⁱⁱ and R^{iv} may independently be a methyl group, an ethyl group, an n-propyl group, an isopropyl group, a cyclopropyl group, a tert-butyl group, an isobutyl group, an n-butyl group, a sec-butyl group, a cyclobutyl group, a cyclopentyl group, a cyclohexyl group, an alkyl group substituted by an aryl group such as an alkylphenyl, a phenyl group which is substituted or not by one or more groups such as an alkyl or cycloalkyl group, an alkoxy group, a halogen, a nitro group, and an acyl group, a naphthyl group which is substituted or not by one or more groups such as an alkyl or cycloalkyl group, an alkoxy group, a halogen, a nitro group, and an acyl group, a heteroaryl group which is substituted or not by one or more groups such as an alkyl or cycloalkyl group, an alkoxy group, a halogen, a nitro group, and an acyl group. As examples of heteroaryl groups, mention may be made of pyridines, pyrroles and carbazoles. Alternatively, Rⁱⁱⁱ and R^{iv} may form part of a ring, for example of a pyrrolidine, of a piperidine, of a morpholine, of a thiomorpholine, or of one of the higher homologs thereof.

According to certain preferred embodiments, Rⁱ and Rⁱⁱ and/or Rⁱⁱⁱ and R^{iv} are all hydrogen atoms.

According to other embodiments, at least one of Rⁱ and Rⁱⁱ and/or at least one of Rⁱⁱⁱ and R^{iv} is a group comprising from 1 to 20 carbon atoms.

According to other embodiments, both of Rⁱ and Rⁱⁱ and/or both of Rⁱⁱⁱ and R^{iv} are independently groups comprising from 1 to 20 carbon atoms.

According to preferred embodiments, the polyamine of formula [Chem 6] may be chosen from ethylenediamine, 1,3-propanediamine, 1,5-pentanediamine, 1,6-hexanediamine, 1,12-dodecanediamine, 2-methyl-1,5-pentanediamine, 3-methyl-1,5-pentanediamine, isophoronediamine, 4,4′-methylenedianiline, 2-methylbenzene-1,4-diamine, diethylenetriamine, 4,6-diethyl-2-methylbenzene-1,3-diamine, 4,4′-methylenedicyclohexaneamine, 2,4,6-trimethyl-1,3-phenylenediamine, and naphthalene-1,8-diamine. More preferably, the polyamine of formula [Chem 6] may be chosen from ethylenediamine and 1,3-propanediamine, and preferably the polyamine of formula [Chem 6] is 1,3-propanediamine.

According to other embodiments, the polyamine may be a polyetheramine comprising two amine groups, preferably primary amine groups. Alternatively, the polyamine may be a secondary or tertiary polyamine comprising two amine groups.

Thus, when it is a polyetheramine comprising two amine groups, it can be of general formula [Chem 7]:

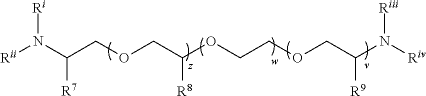

R⁷, R⁸ and R⁹ representing, independently of one another, a group comprising from 1 to 10 carbon atoms, which is linear or branched, saturated or unsaturated and is chosen from an alkyl group, a cycloalkyl group, or an aryl group;

Rⁱ, Rⁱⁱ Rⁱⁱⁱ and R^{iv} representing, independently of one another, a hydrogen atom or a group comprising from 1 to 20 carbon atoms, which is linear or branched, saturated or unsaturated, and is chosen from an alkyl group, a cycloalkyl group, an aryl group or an arylalkyl group;

v, w and z representing, independently of one another, a number from 0 to 90, preferably from 0 to 70.

R⁷, R⁸ and R⁹ may independently represent a group comprising from 1 to 10 carbon atoms, preferably from 1 to 6 carbon atoms, and more preferably from 1 to 2 carbon atoms. These groups may be linear or branched, saturated or unsaturated.

R⁷, R⁸ and R⁹ may independently be chosen from an alkyl group, a cycloalkyl group, or an aryl group, these groups being as described above. Preferably,

at least one of R⁷, R⁸ and R⁹ is an alkyl group, and more preferably a methyl group or an ethyl group.

According to certain preferred embodiments, R⁷, R⁸ and R⁹ may be identical.

According to other embodiments, R⁷, R⁸ and R⁹ may be different from one another.

According to preferred embodiments, at least one of R⁷, R⁸ and R⁹ is a methyl group, and preferably R⁷, R⁸ and R⁹ are methyl groups.

According to preferred embodiments, R⁸ and R⁹ are different from one another.

According to other embodiments, at least one of R⁸ and R⁹ are methyl groups, and the other of R⁸ and R⁹ ethyl groups.

Rⁱ, Rⁱⁱ Rⁱⁱⁱ and R^{iv} are as detailed above. According to certain preferred embodiments, Rⁱ and Rⁱⁱ and/or Rⁱⁱⁱ and R^{iv} are all hydrogen atoms.

According to other embodiments, at least one of Rⁱ and Rⁱⁱ and/or at least one of Rⁱⁱⁱ and R^{iv} is a group comprising from 1 to 20 carbon atoms.

According to other embodiments, both of Rⁱ and Rⁱⁱ and/or both of Rⁱⁱⁱ and R^{iv} are independently groups comprising from 1 to 20 carbon atoms.

According to certain embodiments, v, w and z may independently represent a number from 0 to 90, preferentially from 0 to 70. Thus, v, w and z may independently represent a number from 0 to 10, or from 10 to 20; or from 20 to 30; or from 30 to 40; or from 40 to 50; or from 50 to 60; or from 60 to 70; or from 70 to 80; or from 80 to 90.

According to certain embodiments, z is equal to 0 and v is other than 0.

According to other embodiments, z is other than 0 and v is equal to 0.

According to yet other embodiments, z and v are both other than 0.

When z and v are other than 0, the sum z +v represents the number of substituted ethoxy groups (preferably propoxy or butoxy groups) present in the polyamine of formula [Chem 7].

The sum z +v may or may not be an integer. For example, if a mixture of different alkylene oxides is used, z +v corresponds to the average degree of ethoxylation of the ethoxy groups substituted by R⁸ and R⁹ (preferably to the degree of propoxylation or butoxylation).

When v is equal to 0, the number z represents the number of ethoxy groups substituted by R⁸ (preferably propoxy groups when R⁸ is methyl or butoxy groups when R⁸ is ethyl) present in the polyamine of formula [Chem 7]. When z is equal to 0, the number v represents the number of ethoxy groups substituted by R⁹ (preferably propoxy groups when R⁹ is methyl or butoxy groups when R⁹ is ethyl) present in the polyamine of formula [Chem 7].

The numbers z and v may or may not be integers.

The number w represents the number of ethoxy groups present in the polyamine.

The number w may or may not be an integer. For example, if a mixture of different molecules is used, w corresponds to the average degree of ethoxylation.

According to certain embodiments, v and w may be 0. This type of polyetheramines is for example sold under the names Jeffamine D series and Jeffamine SD series by Huntsman.

According to other embodiments, w may be equal to 0, while v is greater than 0.

According to other embodiments, v and w may be greater than 0.

This type of polyetheramines is for example sold under the name Jeffamine ED series by Huntsman.

The polyetheramines of formula [Chem 7] may have a molecular weight of 100 to 5000 g/mol, preferably of 200 to 4000 g/mol, preferably of 200 to 2000 g/mol and preferably of 200 to 1000 g/mol. For example, the polyetheramines of formula [Chem 7] may have a molecular weight of 100 to 500 g/mol; or of 500 to 750 g/mol; or of 750 to 1000 g/mol; or of 1000 to 1250 g/mol; or of 1250 to 1500 g/mol; or of 1500 to 1750 g/mol; or of 1750 to 2000 g/mol; or of 2000 to 2250 g/mol; or of 2250 to 2500 g/mol; or of 2500 to 2750 g/mol; or of 2750 to 3000 g/mol; or of 3000 to 3250 g/mol; or of 3250 to 3500 g/mol; or of 3500 to 3750 g/mol; or of 3750 to 4000 g/mol; or of 4000 to 4250 g/mol; or of 4250 to 4500 g/mol; or of 4500 to 4750 g/mol; or of 4750 to 5000 g/mol.

According to other embodiments, the polyetheramine comprising two amine groups can be of general formula [Chem 8]

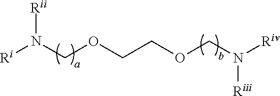

Rⁱ, Rⁱⁱ Rⁱⁱⁱ and R^{iv} representing, independently of one another, a hydrogen atom or a group comprising from 1 to 20 carbon atoms, which is linear or branched, saturated or unsaturated, and is chosen from an alkyl group, a cycloalkyl group, an aryl group or an arylalkyl group;

a and b represent, independently of one another, an integer from 1 to 20, preferentially from 2 to 11.

Rⁱ, Rⁱⁱ Rⁱⁱⁱ and R^{iv} are as described above.

According to certain preferred embodiments, Rⁱ and Rⁱⁱ and/or Rⁱⁱⁱ and R^{iv} are all hydrogen atoms.

According to other embodiments, at least one of Rⁱ and Rⁱⁱ and/or at least one of Rⁱⁱⁱ and R^{iv} is a group comprising from 1 to 20 carbon atoms.

According to other embodiments, both of Rⁱ and Rⁱⁱ and/or both of Rⁱⁱⁱ and R^{iv} are independently groups comprising from 1 to 20 carbon atoms.

According to certain embodiments, a and b may independently represent a number from 1 to 20 and preferably from 2 to 11.

According to certain preferred embodiments, a and b are identical.

Preferably, a and b are equal to 2 or 3.

According to other embodiments, a and b are different. In this case, at least one of a and b is preferably equal to 2 or 3.

The polyetheramines of formula [Chem 8] may have a molecular weight of 150 to 1500 g/mol, preferably of 150 to 1000 g/mol and preferably of 150 to 500 g/mol. For example, the polyetheramines of formula (V) may have a molecular mass of 150 to 160 g/mol; or of 160 to 170 g/mol; or of 170 to 180 g/mol; or of 180 to 190 g/mol; or of 190 to 200 g/mol; or of 200 to 300 g/mol; or of 300 to 400 g/mol; or of 400 to 500 g/mol; or of 500 to 600 g/mol; or of 600 to 700 g/mol; or of 700 to 800 g/mol; or of 800 to 900 g/mol; or of 900 to 1000 g/mol; or of 1000 to 1100 g/mol; or of 1100 to 1200 g/mol; or of 1200 to 1300 g/mol; or of 1300 to 1400 g/mol; or of 1400 to 1500 g/mol.

This type of polyetheramines (formula (V)) is for example sold under the name Jeffamine EDR series by Huntsman.

According to other embodiments, the polyamine may be a primary polyetheramine comprising three amine groups. Alternatively, the polyamine may be a secondary or tertiary polyamine comprising three amine groups. Thus, when it is a polyetheramine comprising three amine groups, it can be of general formula [Chem 9]:

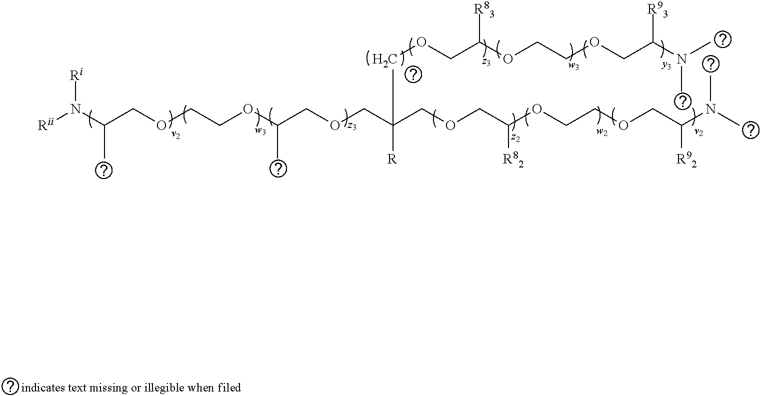

R₁⁸, R₁⁹, R₂⁹, R₂⁹, R₂⁹, R₃⁸, and R₃⁸ representing, independently of one another, a group comprising from 1 to 10 carbon atoms, which is linear or branched, and is chosen from an alkyl group, a cycloalkyl group, or an aryl group;

R representing a hydrogen atom or a group comprising from 1 to 10 carbon atoms, which is linear or branched, saturated or unsaturated and is chosen from an alkyl group, a cycloalkyl group, an arylalkyl group or an aryl group; Rⁱ, Rⁱⁱ Rⁱⁱⁱ and R^{iv} representing, independently of one another, a hydrogen atom or a group comprising from 1 to 20 carbon atoms, which is linear or branched, and is chosen from an alkyl group, a cycloalkyl group, an aryl group or an arylalkyl group;

n representing an integer from 0 to 30, preferentially equal to 0 or 1; and the sums z₁+z₂+z₃, v₁+v₂+v₃ and w₁+w₂+w₃ representing, independently of one another, an integer from 0 to 90, preferentially from 0 to 70, very preferentially from 0 to 50 and more preferentially from 0 to 30.

R₁⁸, R₁⁹, R₂⁸, R₂⁹, R₂⁹, R₃⁸, and R₃⁹ may independently represent a group comprising from 1 to 10 carbon atoms, preferably from 1 to 6 carbon atoms, and more preferably from 1 to 2 carbon atoms. These groups may be linear or branched, saturated or unsaturated.

R₁⁸, R₁⁹, R₂⁸, R₂⁹, R₂⁹, R₃⁸, and R₃⁹ may independently be chosen from an alkyl group, a cycloalkyl group, or an aryl group, these groups being as described above. Preferably, at least one of R₁⁸, R₁⁹, R₂⁸, R₂⁹, R₂⁹, R₃⁸, and R₃⁹ is an alkyl group. More preferably R₁⁸, R₁⁹, R₂⁸, R₂⁹, R₂⁹, R₃⁸, and R₃⁹ are chosen from a methyl group or an ethyl group.

According to certain preferred embodiments, R₁⁸, R₁⁹, R₂⁸, R₂⁹, R₂⁹, R₃⁸, and R₃⁹ may be identical, for example they are all a methyl group.

According to other embodiments, R₁⁸, R₁⁹, R₂⁸, R₂⁹, R₂⁹, R₃⁸, and R₃⁹ may be different from one another.

According to certain embodiments, R₁⁸ is different from R₂⁸ and/or R₃⁹.

According to certain embodiments, R₁⁹ is different from R₂⁹ and/or R₃⁹.

According to preferred embodiments, at least one of R₁⁸, R₁⁹ and/or at least one of R₂⁸, R₂⁹ and/or at least one of R₃⁸, R₃⁹ and/or is a methyl group and the other of R₁⁸, R₁⁹ and/or R₂⁸, R₂⁹ and/or R₃⁸, R₃⁹ and/or is an ethyl group.

R may represent a hydrogen atom or a group comprising from 1 to 10 carbon atoms, and preferably from 1 to 3 carbon atoms. This group may be linear or branched.

According to certain embodiments, R may be chosen from an alkyl group, a cycloalkyl group, an arylalkyl group, or an aryl group, the alkyl, cycloalkyl, arylalkyl and aryl groups being as described above.

When R is a group comprising from 1 to 10 carbon atoms, it is preferably an alkyl group, preferably comprising from 1 to 3 carbon atoms, and preferably from 1 to 2 carbon atoms.

According to certain embodiments, R is a hydrogen atom.

According to other embodiments, R is an ethyl group.

Rⁱ, Rⁱⁱ Rⁱⁱⁱ and R^{iv} are also as detailed above.

According to certain embodiments, z₁, z₂ and z₃ may represent a number from 0 to 80, and preferably from 0 to 70. For example, z₁, z₂ and z₃ may be from 0 to 5; or from 5 to 10; or from 10 to 15; or from 15 to 20; or from 20 to 25; or from 25 to 30; or from 30 to 35; or from 35 to 40; or from 40 to 45; or from 45 to 50; or from 50 to 55; or from 55 to 60; or from 60 to 65; or from 65 to 70; or from 70 to 75; or from 75 to 80. The numbers zi, z2 and z3 may or may not be an integer.

According to certain embodiments, w₁, w₂ and w₃ may represent a number from 0 to 50, and preferably from 0 to 40. For example, w₁, w₂ and w₃ may be from 0 to 5; or from 5 to 10; or from 10 to 15; or from 15 to 20; or from 20 to 25; or from 25 to 30; or from 30 to 35; or from 35 to 40. The numbers w₁, w₂ and w₃ may or may not be an integer.

According to certain embodiments, v₁, v₂ and v₃ may represent a number from 0 to 20, and preferably from 0 to 10. For example, v₁, v₂ and v₃ may be from 0 to 2; or from 2 to 4; or from 4 to 6; or from 6 to 8; or from 8 to 10; or from 10 to 12; or from 12 to 14; or from 14 to 16; or from 16 to 18; or from 18 to 20. The numbers v₁, v₂ and v₃ may or may not be an integer.

According to certain embodiments, at least one of z₁, z₂ and z₃ is other than 0.

According to certain embodiments, at least one of v₁, v₂ and v₃ is other than 0.

According to other embodiments, at least one of z₁, z₂ and z₃ is other than 0, and v₁, v₂ and v₃ are equal to 0.

According to certain embodiments, at least one of w₁, w₂ and w₃ is other than 0.

According to other embodiments, at least one of w₁, w₂ and w₃ is equal to 0, and preferably at least two of w₁, w₂ and w₃ and preferably all three of w₁, and w₃ are equal to 0.

According to certain embodiments, at least one of v₁ and z₁ is equal to 0 and/or at least one of v₂ and z₂ is equal to 0 and/or at least one of v₃ and z₃ is equal to 0.

According to preferred embodiments, at least one of v₁ and z₁ is equal to 0 and/or at least one of v₂ and z₂ is equal to 0 and/or at least one of v₃ and z₃ is equal to 0 and at least one of w₁, w₂ and w₃ is equal to 0, and preferably at least two of w₁, w₂ and w₃ and preferably all three of w₁, w₂ and w₃ are equal to 0.

The sum w₁+w₂+w₃ represents the number of ethoxy groups present in the polyamine of formula [Chem 9].

The sum v₁+v₂+v₃+z₁+z₂+z₃ represents the number of ethoxy groups substituted by R₁⁸, R₁⁸, R₂⁸, R₂⁹, R₃⁸ and R₃⁸ (preferably propoxy or butoxy groups) present in the polyamine of formula [Chem 9].

The sum v₁+v₂+v₃+z₁+z₂+z₃ may or may not be an integer. For example, if a mixture of different alkylene oxides is used, this sum corresponds to the average degree of ethoxylation of the ethoxy groups substituted by R₁⁸, R₁⁸, R₂⁸, R₂⁹, R₃⁸ and R3⁸ (preferably to the degree of propoxylation and/or butoxylation).

The sums z₁+z₂+z₃, v₁+v₂+v₃ and w₁+w₂+w₃ may independently represent a number from 0 to 90, preferentially from 0 to 70, preferentially from 0 to 50 and even more preferentially from 0 to 30. Thus, this number may be from 0 to 10; or from 10 to 20; or from 20 to 30; or from 30 to 40; or from 40 to 50; or from 50 to 60; or from 60 to 70; or from 70 to 80; or from 80 to 90.

According to certain embodiments, when w₁, w₂, w₃, z₁, z₂ and z₃ are equal to 0, v₁+v₂+v₃ may be from 2 to 90, and preferably from 4 to 90. For example, this sum may be from 2 to 5; or from 5 to 10; or from 10 to 20; or from 20 to 30; or from 30 to 40; or from 40 to 50; or from 50 to 60; or 60 or 70; or from 70 to 80; or 80 to 90.

The number n may represent a number from 0 to 30, preferably from 1 to 20, and more preferably from 1 to 10. For example, n may be from 0 to 5; or from 5 to 10; or from 10 to 15; or from 15 to 20; or from 20 to 25; or from 25 to 30. According to certain preferred embodiments, n may be 0 or 1.

The polyetheramines of formula [Chem 9] may have a molecular weight of 300 to 6000 g/mol, preferably of 300 to 5000 g/mol, preferably of 300 to 4000 g/mol and preferably of 300 to 3000 g/mol. For example, the polyetheramines of formula [Chem 9] may have a molecular weight of 300 to 500 g/mol; or of 500 to 750 g/mol; or of 750 to 1000 g/mol; or of 1000 to 1250 g/mol; or of 1250 to 1500 g/mol; or of 1500 to 1750 g/mol; or of 1750 to 2000 g/mol; or of 2000 to 2250 g/mol; or of 2250 to 2500 g/mol; or of 2500 to 2750 g/mol; or of 2750 to 3000 g/mol; or of 3000 to 3250 g/mol; or of 3250 to 3500 g/mol; or of 3500 to 3750 g/mol; or of 3750 to 4000 g/mol; or of 4000 to 4250 g/mol; or of 4250 to 4500 g/mol; or of 4500 to 4750 g/mol; or of 4750 to 5000 g/mol; or of 5000 to 5250 g/mol; or of 5250 to 5500 g/mol; or of 5500 to 5750 g/mol; or of 5750 to 6000 g/mol.

This type of polyetheramine of formula [Chem 9] is for example sold under the names Jeffamine T series and Jeffamine ST series by Huntsman. In all of the formulae above, the groups with indices t, x, y, v, w, z, vᵢ, wᵢ, and zᵢ, may or may not be adjacent in the molecule. For example, ethoxy groups may alternate randomly (according to a certain statistical distribution) with propoxy and/or butoxy groups along the same chain.

Alternatively, other types of polyamines that may be used in the context of the present invention are polyethyleneimines (or polyaziridines), that is to say a polymer comprising a repeating unit composed of the amine group and of the biradical “—CH₂CH₂—” group. These polyamines may be linear, branched or dendrimers. Examples include tetraethylenepentamine, EPOMIN SP012 and also the polyethyleneimines of the Lupasol® name (in particular Lupasol® FG) sold by BASF.

According to the invention, the borane can form a complex with the amine, with a molar ratio of borane to the amine of 0.1 to 10, preferentially of 0.5 to 5, very preferentially of 0.5 to 2. This ratio may in particular be from 0.1 to 0.5; or from 0.5 to 1; or from 1 to 2; or from 2 to 4; or from 4 to 5 or from 5 to 6; or from 6 to 8; or from 8 to 10. For example, when a monoamine is involved, this ratio is preferably approximately 1. However, when a diamine is involved, this ratio is preferably approximately 2.

The borane-amine complex may be used at a content by mass of 0.01% to 25%, and preferably of 0.1% to 10%, relative to the total mass of the radically polymerizable compound. This content may in particular be from 0.01% to 0.1%; or from 0.1% to 1%; or from 1% to 2%; or from 2% to 3%; or from 3% to 4%; or from 4% to 5%; or from 5% to 6%; or from 6% to 7%; or from 7% to 8%; or from 8% to 9%; or from 9% to 10%; or from 10% to 11%; or from 11% to 12%; or from 12% to 13%; or from 13% to 14%; or from 14% to 15%; or from 15% to 16%; or from 16% to 17%; or from 17% to 18%; or from 18% to 19%; or from 19% to 20%; or from 20% to 25%. More particularly, the content of borane-amine complex must be sufficient to allow a complete reaction.

According to preferred embodiments, the borane-amine complex can be prepared according to the process described in patent application EP 2189463 Al filed on March 30, 2009 or according to the process described in the article by P. Veeraraghavan Ramachandran et al. (“Amine—boranes bearing borane-incompatible functionalities: application to selective amine protection and surface functionalization”, Chem. Commun., 2016, 52, 11885), which are incorporated by way of reference, for example by reacting an amine as described above with a borohydride compound, such as sodium borohydride, potassium borohydride or lithium borohydride. This reaction may in particular be carried out in the presence of an acid such as an inorganic acid such as sulfuric acid, methanesulfonic acid, hydrochloric acid, nitric acid, boric acid, and preferably in the presence of sulfuric acid.

### Alkene Compound

The alkene compound shown below is mixed with the borane BH₃-amine complex above in order to obtain a reaction medium comprising an organoborane. The term “organoborane” is understood to mean a compound comprising at least one boron atom bonded to at least one carbon atom by hydroboration. Thus, the borane BH₃-amine complex and the alkene compound can be mixed with a molar ratio of from 1:1 to 1:20 and preferentially from 1:3 to 1:10. For example, the borane BH₃-amine complex and the alkene compound may be present in a molar ratio of 1:1 to 1:5; or from 1:5 to 1:10; or from 1:10 to 1:15; or from 1:15 to 1:20.

According to certain embodiments, the alkene compound may be of general formula [Chem 1]:

H₂C=CH—R¹¹

R¹¹ represents a group comprising from 3 to 31 carbon atoms. This group may be linear or branched. In addition, this group may be chosen from an alkyl group, a cycloalkyl group, an arylalkyl group such as a phenylalkyl group, an —OR¹² group, an —SR group¹² or an —SiR¹³R¹⁴R¹⁵ group. When R¹¹ represents an alkyl group, this group may be devoid of heteroatoms. In other words, the alkyl group can consist of carbon atoms and hydrogen atoms. It may be for example an n-propyl group, an isopropyl group, an n-butyl group, a sec-butyl group, an isobutyl group, a tert-butyl group, a (linear, cyclic or branched) pentyl group, a (linear, cyclic or branched) hexyl group, a (linear, cyclic or branched) heptyl group, a (linear, cyclic or branched) octyl group, a (linear, cyclic or branched) nonyl group, a (linear, cyclic or branched) decyl group, a (linear, cyclic or branched) undecyl group, a (linear, cyclic or branched) dodecyl group, a (linear, cyclic or branched) tridecyl group, a (linear, cyclic or branched) tetradecyl group, a (linear, cyclic or branched) pentadecyl group, a (linear, cyclic or branched) hexadecyl group, a (linear, cyclic or branched) heptadecyl group, a (linear, cyclic or branched) octadecyl group, a (linear, cyclic or branched) nonadecyl group, a (linear, cyclic or branched) eicosanyl group, a (linear, cyclic or branched) heneicosanyl group, a (linear, cyclic or branched) docosanyl group or the mixtures thereof such as the linear and branched C20-24 Alpha Olefins available from INEOS OLIGOMERS or the Linear Alpha Olefins available from IDEMITSU KOSAN under the commercial reference LINEALENE.

Alternatively, when R¹¹ represents an alkyl group, this group may comprise at least one heteroatom, in particular an oxygen atom and/or a sulfur atom or and/or a silicon atom and/or a halogen chosen from fluorine, chlorine, bromine and iodine atoms. For example, it may be a linear alkyl chain which comprises a heteroatom group as an end group or as a divalent radical (that is to say present in the alkyl chain between two alkyl groups) or as a side group on the alkyl chain. In this case, the alkene compound can have one of the following formulae:

H₂C═CH—(CH₂)ₘ—O—R¹⁹ General formula [Chem 10]

In the formula [Chem 10], m may be from 1 to 9, and R¹⁹ may be a group comprising from 1 to 22 carbon atoms, this group possibly being linear or branched; R¹⁹ may be an alkyl group, a cycloalkyl group, an aryl group, an alkylaryl group or a cycloalkyl group, these groups being as described below. The aryl group may be for example a phenyl group, a substituted phenyl group (see alkylaryl below) or a heteroaryl group such as a pyridine, a pyrrole, or a carbazole. The alkyl, alkylaryl and cycloalkyl groups are as described below.

H₂C═CH—(CH₂)ᵣ—O—[CH₂—CH(R²⁰)—O]ₒ—R²¹ General formula [Chem 11]

In the formula [Chem 11], r may be from 1 to 9, to may be from 1 to 340 and R₂₀ may be a hydrogen atom or a group comprising from 1 to 6 carbon atoms, this group possibly being linear or branched; R²¹ may be a group comprising from 1 to 22 carbon atoms, this group being linear, cyclic or branched. R²¹ may be an alkyl group, a cycloalkyl group, an alkylaryl group or an aryl group, these groups being as described above.

H₂C═CH—(CH₂)ₚ—COOR²² General formula [Chem 12]

In the formula [Chem 12], p may be from 1 to 8, and R²² may be a group comprising from 1 to 22 carbon atoms, this group possibly being linear or branched; R²² may be an alkyl group, a cycloalkyl group, an arylalkyl group or an aryl group, these groups being as described above.

H₂C═CH—(CH₂)_{q}—SiR¹³R¹⁴R¹⁵ General formula [Chem 13]

In the formula [Chem 13], q may be from 1 to 9, and the groups R¹³, R¹⁴ and R¹⁵ may be chosen, independently of one another, from a linear or branched alkyl group, a cycloalkyl group, an arylalkyl group, an aryl group or an alkoxy group. These groups may comprise from 1 to 20, preferably from 1 to 10, and more preferably from 1 to 5 carbon atoms and they may be (independently of one another) linear or branched groups.

According to certain embodiments, at least one of R¹³, R¹⁴ and R¹⁵, preferably at least two of R¹³, R¹⁴ and R¹⁵, and more preferably the three groups R¹³, R¹⁴ and R¹⁵ are alkoxy groups, such as for example a methoxy group, an ethoxy group, a propoxy group or a butoxy group.

According to other embodiments, at least one of R¹³, R¹⁴ and R¹⁵, preferably at least two of R¹³, R¹⁴ and R¹⁵, and more preferably the three groups R¹³, R¹⁴ and R¹⁵ are alkyl groups, such as for example a methyl group, an ethyl group, an isopropyl group, an n-butyl group, an isobutyl group, a sec-butyl group or a tert-butyl group.

H₂C═CH—(CH₂)ᵣ—O—(CH₂)ₛ—SiR¹³R¹⁴R¹⁵ General formula [Chem 14]

In the formula [Chem 14], r may be as described above, s may be from 2 to 11 carbon atoms, and the groups R¹³, R¹⁴ and R¹⁵ may be as described above. According to certain embodiments, at least one of R¹³, R¹⁴ and R¹⁵, preferably at least two of R¹³, R¹⁴ and R¹⁵, and more preferably the three groups R¹³, R¹⁴ and R¹⁵ are alkoxy groups, such as for example a methoxy group, an ethoxy group, a propoxy group or a butoxy group.

According to other embodiments, at least one of R¹³, R¹⁴ and R¹⁵, preferably at least two of R¹³, R¹⁴ and R¹⁵, and more preferably the three groups R¹³, R¹⁴ and R¹⁵ are alkyl groups, such as for example a methyl group, an ethyl group, an n-propyl group, an isopropyl group, an n-butyl group, an isobutyl group, a sec-butyl group or a tert-butyl group.

H₂C═CH—(CH₂)ₖ—Hal General formula [Chem 15]

In the formula [Chem 15], k may be from 3 to 30, and Hal may be a halogen chosen from fluorine, chlorine, bromine and iodine atoms. Preferably, the halogen is bromine.

According to other embodiments, at least one of R¹³, R¹⁴ and R¹⁵, preferably at least two of R¹³, R¹⁴ and R¹⁵, and more preferably the three groups R¹³, R¹⁴ and R¹⁵ are alkyl groups, such as for example a methyl group, an ethyl group, an isopropyl group, a tert-butyl group or an isobutyl group.

When R¹¹ is an arylalkyl group, it may be an alkyl group substituted by one or more aryl groups, these groups preferably being aryl groups comprising from 4 to 10, and preferably from 4 to 6 carbon atoms, such as a furanyl group or a phenyl group.

When R¹¹ represents a cycloalkyl group, it may be a cyclopropyl group, a cyclobutyl group, a cyclopentyl group, or a cyclohexyl group. It may also be a cycloalkyl substituted by one or more groups, these groups preferably being alkyl groups comprising from 1 to 10, and preferably from 1 to 5 carbon atoms, such as a methyl group, an ethyl group, an n-propyl group, an isopropyl group, an n-butyl group, an isobutyl group, a sec-butyl group or a tert-butyl group.

When R¹¹ represents an —OR¹² group, the R¹² group is chosen from a linear or branched alkyl group (comprising from 3 to 30 carbon atoms), a cycloalkyl group, an arylalkyl group or an acyl group.

The arylalkyl group is as described above.

The cycloalkyl group is as described above.

According to other embodiments, the R¹² group may comprise one or more heteroatoms, preferably oxygen atoms. Thus, the R¹² group may comprise an acyl group such as a —COOR¹⁶ group. In this case R¹⁶ can be chosen from a linear or branched alkyl group, a cycloalkyl group, or an arylalkyl group. When R¹¹ represents an —SR¹² group, the R¹² group is chosen from a linear, cyclic or branched alkyl group (comprising from 3 to 30 carbon atoms), a cycloalkyl group, an arylalkyl group, an alkylaryl group or an acyl group. The R¹² group is as described above. Finally, when R¹¹ represents an —SiR¹³R¹⁴R¹⁵ group, the R¹³, R¹⁴ and R¹⁵ groups can be as described above.

According to certain embodiments, at least one of R¹³, R¹⁴ and R¹⁵, preferably at least two of R¹³, R¹⁴ and R¹⁵, and more preferably the three groups R¹³, R¹⁴ and R¹⁵ are alkoxy groups, such as for example a methoxy group, an ethoxy group, a propoxy group or a butoxy group.

According to other embodiments, at least one of R¹³, R¹⁴ and R¹⁵, preferably at least two of R¹³, R¹⁴ and R¹⁵, and more preferably the three groups R¹³, R¹⁴ and R¹⁵ are alkyl groups, such as for example a methyl group, an ethyl group, an n-propyl group, an isopropyl group, an n-butyl group, an isobutyl group, a sec-butyl group or a tert-butyl group.

According to preferred embodiments, the alkene compounds of formula [Chem 1] may include: octene, decene, vinylcyclohexane, vinylbenzene, vinyltoluene, vinylsilanes, vinylalkoxysilanes such as vinyltrimethoxysilane and vinyltriethoxysilane, 1 -(vinyloxy)propane, 1-(vinyloxy)dodecane, 1-(vinyloxy)octadecane, (vinyloxy)cyclohexane, 1-(vinyloxy)butane, 1-(vinyloxy)isobutane, tert-butyl vinyl ether, phenyl vinyl ether, phenyl vinyl sulfide, vinyl methacrylate, vinyl acetate or vinyl esters (for example the vinyl ester Veova from Hexion).

According to certain embodiments, the alkene compound may be of general formula [Chem 2]:

H₂CH—CH₂—R¹¹

R¹¹ is as described above.

According to preferred embodiments, the alkene compounds of formula

[Chem 2] may include: allyl phenyl ether, allyl phenyl thioether, allyl methacrylate, allyl glycidyl ether, methyl 2-((allyloxy)methyl)acrylate and allyl trimethylsilane.

According to certain embodiments, the alkene compound may be of general formula [Chem 3]:

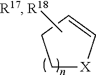

In this formula [Chem 3], X is an oxygen atom, a sulfur atom or a bridge-forming —CH₂— divalent radical.

Moreover, n is an integer from 2 to 10. Preferably, n is from 2 to 8.

According to certain embodiments, the alkene compound of formula [Chem 3] comprises not only one but several double bonds in its ring, for example two or three double bonds.

According to certain embodiments, n is 2 and X is a bridge-forming —CH₂— divalent radical. In this case, the alkene compound of formula [Chem 3] has the structure of norbornene.

The R¹⁷ and R¹⁸ groups represent, independently of one another, a hydrogen atom, a linear or branched alkyl group comprising from 1 to 10 carbon atoms, a linear or branched alkene group comprising from 1 to 10 carbon atoms or a —CH₂— divalent radical forming a bridge with the ring.

According to certain embodiments, at least one of R¹⁷ and R¹⁸ represents a linear alkyl group having from 2 to 8 carbon atoms.

According to certain embodiments, at least one of R¹⁷ and R¹⁸ represents a linear alkene group having from 1 to 5 carbon atoms.

According to certain embodiments, at least one of R¹⁷ and R¹⁸ represents a hydrogen atom. Alternatively, both of R¹⁷ and R¹⁸ represent a hydrogen atom.

Preferred alkene compounds of formula [Chem 3] may be 2,3-dihydrofuran, 3,4-dihydro-2H-pyran, 2,3,4,5-tetrahydrooxepine, or 3,4,5,6-tetrahydro-2H-oxocine.

According to preferred embodiments, the alkene compound may be chosen from octene, decene, allyltrimethylsilane, vinyltrimethoxysilane and vinyltriethoxysilane.

According to certain embodiments, a single alkene compound is mixed with the borane BH₃-amine complex.

Alternatively, more than one alkene compound, for example two or three or four or five alkene compounds, can be mixed with the borane BH₃-amine complex.

The alkene compound is used at a content by mass of 0.01% to 95%, preferably of 0.01% to 25%, and more preferably of 0.1% to 10%, relative to the total mass of the radically polymerizable compound. This content may in particular be from 0.01% to 0.1%; or from 0.1% to 1%; or from 1% to 5%; or from 5% to 10%; or from 10% to 15%; or from 15% to 20%; or from 20% to 25%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%; or from 70% to 75%; or from 75% to 80%; or from 80% to 85%; or from 85% to 90%; or from 90% to 95%.

It is moreover preferable for the alkene compound to be liquid in a temperature range of from 20° C. to 30° C., and preferably from 23° C. to 25° C.

Radically Polymerizable Compound

The composition that will be polymerized (composition to be polymerized) comprises at least one radically polymerizable compound comprising at least one ethylenic bond. “Radical polymerization” is a chain polymerization which involves radicals as active species. It involves initiation, propagation, termination and chain transfer reactions. Thus, the borane present in the reaction medium can initiate the polymerization of the polymerizable compound(s) to form a polymer or a network of polymer(s). The radically polymerizable compound may comprise any monomer, oligomer or polymer, and also mixtures thereof, comprising an olefinic unsaturation and being polymerizable by the radical route. For example, the radically polymerizable compound may be chosen from styrene monomers, acrylic monomers and methacrylic monomers. These may include styrene and α-methylstyrene, acrylic and methacrylic monomers or oligomers such as acrylic acid, methacrylic acid, acrylonitrile, methacrylonitrile, acrylic acid amides (or acrylamides), methacrylic acid amides (or methacrylamides), acrylic acid esters (or acrylates) and methacrylic acid esters (or methacrylates).

According to preferred embodiments, the radically polymerizable compound is an acrylic or methacrylic monomer such as acrylic acid, methacrylic acid, acrylonitrile, methacrylonitrile, acrylamides, methacrylamides, acrylates and methacrylates.

The radically polymerizable compound may for example be chosen from acrylic acid, methacrylic acid, acrylate monomers, methacrylate monomers, and mixtures thereof, the alkyl group of the acrylic esters (acrylates) and methacrylic esters (methacrylates) preferably comprising from 1 to 22 carbon atoms, being saturated or unsaturated, linear, branched or cyclic, and possibly including at least one heteroatom (0, S) or one ester function (—COO—); and the alkyl group preferably comprising from 1 to 12 carbon atoms and being linear, branched or cyclic.

Advantageously, the radically polymerizable compound may be chosen from alkyl and cycloalkyl acrylates and methacrylates such as acrylic acid, methyl acrylate, ethyl acrylate, n-propyl acrylate, isopropyl acrylate, allyl acrylate, n-butyl acrylate, isobutyl acrylate, t-butyl acrylate, n-hexyl acrylate, n-octyl acrylate, isooctyl acrylate (SR440 sold by Sartomer), 2-ethylhexyl acrylate, n-decyl acrylate, isodecyl acrylate (SR395 sold by Sartomer), lauryl acrylate (SR335 sold by Sartomer), tridecyl acrylate (SR489 sold by Sartomer), C12-C14 alkyl acrylate (SR336 sold by Sartomer), n-octadecyl acrylate (SR484 sold by Sartomer), C16-C18 alkyl acrylate (SR257C sold by Sartomer), cyclohexyl acrylate, t-butylcyclohexyl acrylate (SR217 sold by Sartomer), 3,3,5-trimethylcyclohexyl acrylate (SR420 sold by Sartomer), isobornyl acrylate (SR506D sold by Sartomer), methacrylic acid, methyl methacrylate, ethyl methacrylate, n-propyl methacrylate, allyl methacrylate, isopropyl methacrylate, n-butyl methacrylate, isobutyl methacrylate, t-butyl methacrylate, cyclohexyl methacrylate, n-hexyl methacrylate, n-octyl methacrylate, isooctyl methacrylate, 2-ethylhexyl methacrylate, isobornyl methacrylate, n-decyl methacrylate, isodecyl methacrylate, n-dodecyl methacrylate, tridecyl methacrylate, and mixtures thereof. Particularly preferred compounds are methyl acrylate, ethyl acrylate, butyl acrylate, 2-ethylhexyl acrylate, methyl methacrylate, ethyl methacrylate, butyl methacrylate and 2-ethylhexyl methacrylate.

In addition, the radically polymerizable compound may be chosen from acrylates and methacrylates comprising heteroatoms, that is to say acrylates and methacrylates which contain at least one atom which is not a carbon or hydrogen in the group of the alcohol part of the ester (without taking into account the atoms of the ester group itself). Preferably, the atom is an oxygen. Thus, the radically polymerizable compound may be chosen from tetrahydrofurfuryl acrylate (SR285 sold by Sartomer), tetrahydrofurfuryl methacrylate (SR203H sold by Sartomer), glycidyl acrylate, 2-hydroxyethyl acrylate, 2- and 3-hydroxypropyl acrylate, 2-methoxyethyl acrylate, 2-ethoxyethyl acrylate, 2- and 3-ethoxypropyl acrylate, 2-(2-ethoxyethoxy)ethyl acrylate (SR256 sold by Sartomer), methoxypolyethylene glycol acrylate (preferably comprising 2 to 8 (ethoxy) repeating units), polyethylene glycol acrylate (preferably comprising 2 to 8 (ethoxy) repeating units), polypropylene glycol acrylate (preferably comprising 2 to 8 (propoxy) repeating units), polycaprolactone acrylate (SR495B sold by Sartomer), 2-phenoxyethyl acrylate (SR339C sold by Sartomer), 2-[2-[2-(2-phenoxyethoxy)ethoxy]ethoxy]ethyl acrylate (SR410 sold by Sartomer), 2-[2-[2-(2-nonylphenoxyethoxy)ethoxy]ethoxy]ethyl acrylate (SR504D sold by Sartomer), cyclic trimethylolpropane formal acrylate (SR531 sold by Sartomer), cyclic glycerol formal acrylate, 2-[2-[2-(2-dodecyloxyethoxy)ethoxy]ethoxy]ethyl acrylate (SR9075 sold by Sartomer), glycidyl methacrylate, 2-hydroxyethyl methacrylate, 2- and 3-hydroxypropyl methacrylate, 2-methoxyethyl methacrylate, 2-ethoxyethyl methacrylate, 2- and 3-ethoxypropyl methacrylate, 2-(2-ethoxyethoxy)ethyl methacrylate, methoxypolyethylene glycol methacrylate (preferably comprising 2 to 8 (ethoxy) repeating units), polyethylene glycol methacrylate (preferably comprising 2 to 8 (ethoxy) repeating units), polypropylene glycol methacrylate (preferably comprising 2 to 8 (propoxy) repeating units), cyclic trimethylolpropane formal methacrylate, cyclic glycerol formal methacrylate (Visiomer® Glyfoma sold by Evonik) and mixtures thereof. Acrylates and methacrylates of ethylene glycol, diethylene glycol, trimethylpropane, triethylene glycol, tetraethylene glycol, dipropylene glycol, tripropylene glycol, tetrapropylene glycol, and pentapropylene may also be used. Particularly preferred compounds are 2-hydroxyethyl acrylate, 2-hydroxypropyl acrylate, polycaprolactone acrylate, 2-hydroxyethyl methacrylate, 2-hydroxypropyl methacrylate and polycaprolactone methacrylate.

Diacrylate and dimethacrylate compounds may also be used within the context of this invention. Such compounds include ethylene glycol diacrylate, 1,3-butylene glycol diacrylate, 1,4-butanediol diacrylate, 1,6-hexanediol diacrylate (SR238 sold by Sartomer), 3-methyl-1,5-pentanediol diacrylate (SR341 sold by Sartomer), cyclohexanedimethanol diacrylate, neopentyl glycol diacrylate, 1,10-decanediol diacrylate (SR595 sold by Sartomer), tricyclodecanedimethanol diacrylate (SR833S sold by Sartomer), esterdiol diacrylate (SR606A sold by Sartomer), alkoxylated aliphatic diacrylates such as diethylene glycol diacrylate, triethylene glycol diacrylate (SR272 sold by Sartomer), dipropylene glycol diacrylate (SR508 sold by Sartomer), tripropylene glycol diacrylate (SR306 sold by Sartomer), tetraethylene glycol diacrylate (SR268G sold by Sartomer), ethoxylated and/or propoxylated cyclohexanedimethanol diacrylates, ethoxylated and/or propoxylated hexanediol diacrylates, ethoxylated and/or propoxylated neopentyl glycol diacrylates, caprolactone-modified neopentyl glycol hydroxypivalate diacrylate, dipropylene glycol diacrylate, ethoxylated (3) bisphenol A diacrylate (SR349 sold by Sartomer), ethoxylated (10) bisphenol A diacrylate (SR602 sold by Sartomer), ethoxylated (30) bisphenol A diacrylate, ethoxylated (40) bisphenol A diacrylate, polyethylene glycol (200) diacrylate (SR259 sold by Sartomer), polyethylene glycol (400) diacrylate (SR344 sold by Sartomer), polyethylene glycol (600) diacrylate (SR610 sold by Sartomer), propoxylated neopentyl glycol diacrylates, ethylene glycol dimethacrylate, 1,3-butylene glycol dimethacrylate, 1,4-butanediol dimethacrylate, 1,6-hexanediol dimethacrylate, 3-methyl-1,5-pentanediol dimethacrylate, 1,6-hexanediol monoacrylate monomethacrylate, cyclohexanedimethanol dimethacrylate, neopentyl glycol dimethacrylate, tricyclodecanedimethanol dimethacrylate, alkoxylated aliphatic methacrylates such as triethylene glycol dimethacrylate, tripropylene glycol dimethacrylate, tetraethylene glycol dimethacrylate, ethoxylated and/or propoxylated cyclohexanedimethanol dimethacrylates, ethoxylated and/or propoxylated hexanediol dimethacrylates, ethoxylated and/or propoxylated neopentyl glycol dimethacrylates, caprolactone-modified neopentyl glycol hydroxypivalate dimethacrylate, diethylene glycol dimethacrylate, dipropylene glycol dimethacrylate, tripropylene glycol dimethacrylate, ethoxylated (10) bisphenol

A dimethacrylate, ethoxylated (3) bisphenol A dimethacrylate, ethoxylated (30) bisphenol A dimethacrylate, ethoxylated (40) bisphenol A dimethacrylate, polyethylene glycol (200) dimethacrylate, polyethylene glycol (400) dimethacrylate, polyethylene glycol (600) dimethacrylate, ethoxylated and/or propoxylated neopentyl glycol dimethacrylates and mixtures thereof.

Triacrylate and trimethacrylate compounds may also be used within the context of this invention. Such compounds include glyceryol trimethacrylate, glycerol triacrylate, ethoxylated and/or propoxylated glycerol triacrylates, trimethylolpropane triacrylate (SR351 sold by Sartomer), ethoxylated and/or propoxylated trimethylolpropane triacrylates, pentaerythritol triacrylate (SR444D sold by Sartomer), ethoxylated and/or propoxylated trimethylolpropane triacrylates, trimethylolpropane trimethacrylate, and tris(2-hydroxyethyl)isocyanurate triacrylate (SR368 sold by Sartomer), tris(2-hydroxyethyl)isocyanurate trimethacrylate, ethoxylated and/or propoxylated glycerol trimethacrylates, ethoxylated and/or propoxylated trimethylolpropane trimethacrylates, and pentaerythritol trimethacrylate.

Compounds comprising more than three acrylate or methacrylate groups may also be used such as, for example, pentaerythritol tetraacrylate (SR295 sold by Sartomer), ditrimethylolpropane tetraacrylate (SR355 sold by Sartomer), dipentaerythritol pentaacrylate (SR399 sold by Sartomer), ethoxylated and/or propoxylated pentaerythritol tetraacrylates, pentaerythritol tetramethacrylate, ditrimethylolpropane tetramethacrylate, dipentaerythritol pentamethacrylate and ethoxylated and/or propoxylated pentaerythritol tetramethacrylates.

In addition, the radically polymerizable compound may be chosen from acrylic and methacrylic oligomers such as urethane-acrylates and urethane-methacrylates, polyester-acrylates, polyester-methacrylates, polybutadiene-acrylates (SR307 sold by Sartomer) and polybutadiene-methacrylates. Preferred compounds in this category are for example CN1963, CN1964, CN992, CN981, CN9001, CN9002, CN9012, CN9200, CN964A85, CN965, CN966H90, CN991, CN9245S, CN998B80, CN9210, CN9276, CN9209, PRO21596, CN9014NS, CN9800, CN9400, CN9167, CN9170A86, CN9761 and CN9165A, sold by Sartomer.

Radically polymerizable compounds that may be used within the context of the invention may also include acrylamides and methacrylamides. For example, these monomers may be chosen from acrylamide, methacrylamide, N-(hydroxymethyl)acrylamide, N-(hydroxyethyl)acrylamide, N-(isobutoxymethyl)acrylamide, N-(3-methoxypropyl)acrylamide, N-[tris(hydroxymethyl)methyl]acrylamide, N-isopropylacrylamide, N-[3-(dimethylamino)propyl]methacrylamide, diacetone acrylamide, N,N′-methylenedimethacrylamide, N,N′-methylenediacrylamide, N,N′-(1,2-dihydroxyethylene)bismethacrylamide and N,N′-(1,2-dihydroxyethylene)bisacrylamide and also from the acrylamides and methacrylamides formed after reaction of acrylic or methacrylic acid (or of the acyl chloride of this acid) with primary and/or secondary (poly)amines such as 1,3-diaminopropane, N,N′-dimethyl-1 ,3-diaminopropane, 1,4-diaminobutane, polyamidoamines and polyoxyalkylenepolyamines.

According to certain embodiments, a single radically polymerizable compound is present in the composition to be polymerized.

According to other embodiments, several radically polymerizable compounds are present in the composition to be polymerized.

The radically polymerizable compound(s) may be present in the composition at a content by mass of 10% to 100%, and preferably of 30% to 95%, relative to the total mass of the composition. This content may for example be from 10% to 15%; or from 15% to 20%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%; or from 70% to 75%; or from 75% to 80%; or from 80% to 85%; or from 85% to 90%; or from 90% to 95%; or from 95% to 100%.

Polymerization Process

The polymerization process according to the invention comprises the following steps:

bringing a borane-amine complex into contact with an alkene compound as

described opposite so as to obtain a reaction mixture; and

bringing a composition comprising the at least one radically polymerizable compound comprising at least one ethylenic bond as described opposite into contact with the reaction medium obtained.

Aside from the radically polymerizable compound, the composition may also comprise one or more additives chosen from fillers or dyes, solvents or plasticizers, UV and heat stabilizers, moisture absorbers, fluorescent materials and transfer agents.

The fillers may be chosen from talc, mica, kaolin, bentonite, aluminum oxides, titanium oxides, iron oxides, barium sulfate, hornblende, amphiboles, chrysotile, carbon black, carbon fibers, fumed or pyrogenic silicas, molecular sieves, calcium carbonate, wollastonite, glass beads, glass fibers, and combinations thereof. The fillers may also include nanofillers, such as carbon nanofibers, carbon nanotubes, etc.

As regards the plasticizer, this may be chosen from plasticizers known to those skilled in the art in the polymer synthesis industries. Mention may be made, for example, of plasticizers based on phthalates, polyol esters (such as, for example, pentaerythritol tetravalerate, sold by Perstorp), epoxidized oil, alkylsulfonic esters of phenol (the Mesamoll® product sold by Lanxess) and mixtures thereof.

The solvent may also be chosen from those known to those skilled in the art in the polymer synthesis industries. Mention may be made, by way of example, of tetrahydrofuran (THF), hexane, acetonitrile, DMSO or even ethanol.

The UV stabilizers may be chosen from benzotriazoles, benzophenones, “hindered” amines, such as butylated hydroxytoluene, 4-methoxyphenol, bis(2,2,6,6-tetramethyl-4-piperidyl) sebacate, and mixtures thereof. Mention may be made, for example, of the products Tinuvin® 328 or Tinuvin® 770, sold by BASF.

The fluorescent material may for example be 2,5-thiophenediylbis(5-tert-butyl-1,3-benzoxazole) (Uvitex® OB).

The transfer agents can be chosen from 1,8-dimercapto-3,6-dioxaoctane (DMDO), n-dodecylmercaptan (NDM) or n-octylmercaptan (NOM). These agents make it possible to control the molecular mass of the final polymer.

The additives may be present in the composition at a content by mass of 0.01% to 5%, and preferably of 0.01% to 3%, relative to the total mass of the composition. Thus, the additives may in particular be present in the composition at a content by mass of 0.01% to 0.1%; or of 0.1% to 0.5%; or of 0.5% to 1%; or of 1% to 2.5%; or of 2.5% to 5%; or of 5% to 10%; or of 10% to 15%; or of 15% to 20%; or of 20% to 25%; or of 25% to 30%. The preparation of the reaction medium from the composition comprising the borane-amine complex and the alkene compound can be carried out by simple mixing of the borane-amine (BH₃-amine) complex and the alkene compound at a temperature ranging from 20 to 60° C., and preferably from 35 to 55° C. Thus, this temperature may in particular be from 20 to 25° C.; or 25 to 30° C.; or 30 to 35° C.; or 35 to 40° C.; or 40 to 45° C.; or 45 to 50° C.; or 50 to 55° C.; or 55 to 60° C. for a period that can range from 1 minute to 24 hours.

The reaction medium obtained can be introduced into the composition to be polymerized (composition comprising the at least one radically polymerizable compound comprising at least one ethylenic bond). Bringing the borane-amine complex/alkene mixture into contact with the composition to be polymerized can, for example, be carried out by simple mixing. This mixing may for example be carried out at ambient temperature.

After the step of introducing and bringing the reaction medium into contact with the composition to be polymerized, the process according to the invention may comprise a step of heating the mixture obtained so as to facilitate the polymerization of the polymerizable compound(s). According to certain embodiments, the heating can be carried out at a temperature of 20 to 100° C., and preferably of 35 to 85° C. Thus, this temperature can in particular be from 20 to 25° C.; or from 25 to 30° C.; or from 30 to 35° C.; or from 35 to 40° C.; or from 40 to 45° C.; or from 45 to 50° C.; or from 50 to 55° C.; or from 55 to 60° C.; or from 60 to 65° C.; or from 65 to 70° C.; or from 70 to 75° C.; or from 75 to 80° C.; or from 80 to 85° C.; or from 85 to 90° C.; or from 90 to 95° C.; or from 95 to 100° C.

According to preferred embodiments, the polymerization process according to the invention is carried out in the absence of decomplexing agents for decomplexing the borane and the amine. The term “decomplexing agent” is understood to mean a compound capable of reacting with the amine present in the borane-amine complex in order to release the borane. For example, the decomplexing agent may an isocyanate, a Lewis acid, a carboxylic acid, a mineral acid, a phosphonic acid, a sulfonic acid, an acyl chloride, an anhydride, an aldehyde, a 1,3-dicarbonyl compound and an epoxide. Preferably, the polymerization process according to the invention is carried out in the absence of isocyanate compound.

The polymerization of the radically polymerizable compound may have a duration of from 15 minutes to 3 days, and preferably from 30 minutes to 2 days.

The polymerization process according to the invention makes it possible to obtain polymers having a number-average molar mass of 1000 to 2 000 000 g/mol, preferably from 1000 to 500 000 g/mol and preferably from 1000 to 250 000 g/mol. The number-average molecular mass can be measured by gel permeation chromatography (GPC).

The invention thus provides a polymerizable composition comprising at least one radically polymerizable compound by the radical route (as described above) and an alkene/borane-amine (BH₃-amine) complex composition, obtained as described above. This composition is devoid of decomplexing agents to decomplex the borane and the amine. In other words, the polymerizable composition comprises the composition described above comprising the radically polymerizable compound and the alkene/borane-amine complex composition and it may be formed by mixing the composition to be polymerized, described above, comprising the radically polymerizable compound with the alkene/borane-amine complex composition.

### EXAMPLES

The examples that follow illustrate the invention without limiting it.

### Example 1

In this example, various alkene compounds are used for the polymerization of methyl methacrylate using a reaction medium comprising a borane-amine complex and an alkene compound. The polymerization is carried out from a composition comprising 100% of methyl methacrylate at 60° C. and with a molar content of 1% of borane-amine complex relative to the mass of the methyl methacrylate. The amine used is N-ethyldiisopropylamine. More particularly, initially, the borane-N-ethyldiisopropylamine complex is mixed with the alkene compound at ambient temperature and the reaction medium obtained is mixed with the composition comprising the methacrylic monomer, before heating to 60° C.

The table below includes various alkene compounds used to obtain the reaction medium (reactions 1 to 5).

The term “reaction time” is understood to mean the duration of polymerization from the moment at which the polymerizable compound is mixed with the reaction medium up to the moment that the polymer is formed (the polymer formed is in the solid state whereas the initial mixture of reaction medium with the polymerizable compound is in the liquid state).

TABLE 1

| Reactions | Alkene | Reaction time | |
|---|---|---|---|
| 1 | Vinyltriethoxysilane | 3 | days |
| 2 | Allyltrimethylsilane | 6 | h |
| 3 | Allyl bromide | >5 | days |
| 4 | 4-Bromo-1-butene | 20 | hr |
| 5 | Tert-butyl vinyl ether | 5 | hr |

It is observed that the process according to the invention makes it possible to synthesize methacrylic polymers in an efficient manner using various alkenes.

### Example 2

Next, the polymerization of styrene according to the process of the invention is studied. The table below includes various alkene compounds used to obtain the reaction medium (reactions 6 to 10). As mentioned above, the polymerization is carried out with 1% organoborane-amine complex and at a temperature of 60° C.

TABLE 2

| Reactions | Alkene | Reaction time | |
|---|---|---|---|
| 6 | Ally-para-cresol | 2 | d |
| 7 | Allyltrimethylsilane | >5 | days |
| 8 | Allyl bromide | >5 | days |
| 9 | 4-Bromo-1-butene | 20 | hr |
| 10 | Decene | 2 | d |

It is observed that the process according to the invention makes it possible to synthesize styrene polymers in an efficient manner using different borane-amine complexes.

1-9. (canceled)

10. A process for polymerizing at least one radically polymerizable compound comprising at least one ethylenic bond, comprising the following steps:
bringing a borane BH₃-amine complex into contact with an alkene compound so as to obtain a reaction medium; and
bringing a composition comprising the at least one radically polymerizable compound comprising at least one ethylenic bond into contact with the reaction medium obtained;
said alkene compound being selected from the group consisting of:
1) an alkene compound of general formula [Chem 1]
H₂C═CH—R¹¹
representing a group comprising from 3 to 31 carbon atoms selected from the group consisting of a linear or branched alkyl group, an arylalkyl group, a cycloalkyl group, an —OR¹² group, an —SR¹² group and an —SiR¹³R¹⁴R¹⁵ group;
R¹² being selected from the group consisting of a linear or branched alkyl group, an arylalkyl group, a cycloalkyl group, an acyl group and a —COR¹⁶ group; and
R¹³, R¹⁴, R¹⁵ being selected from the group consisting of, independently of one another, a linear or branched alkyl group, an aryl group, a cycloalkyl group and an alkoxy group;
2) an alkylene compound of general formula [Chem 2]
H₂C═CH—CH₂—R¹¹
R¹¹ representing a group comprising from 3 to 31 carbon atoms selected from the group consisting of a linear or branched alkyl group, an arylalkyl group, a cycloalkyl group, an -—OR¹² group, an —SR¹² group and an —SiR¹³R¹⁴R¹⁵ group;
R¹² being selected from the group consisting of a linear or branched alkyl group, an arylalkyl group, a cycloalkyl group and an acyl group; and
R¹³, R¹⁴, R¹⁵ being selected from the group consisting of, independently of one another, a linear or branched alkyl group, an aryl group, a cycloalkyl group and an alkoxy group; or
3) an alkene compound of general formula [Chem 3] 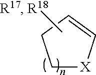
X being an oxygen atom, a sulfur atom or a bridge-forming —CH₂— divalent radical;
n being an integer from 2 to 10; and
R¹⁷ and R¹⁸ representing, independently of one another, a hydrogen atom, a linear or branched alkyl group comprising from 1 to 10 carbon atoms, a linear or branched alkene group comprising from 1 to 10 carbon atoms or a —CH₂— divalent radical forming a bridge with the ring.

11. The polymerization process as claimed in claim 10, wherein the amine is selected from the group consisting of diisopropylamine, N-methyldiisopropylamine, N-ethyldiisopropylamine, dicyclohexylamine, N-methyldicyclohexylamine, N-ethyldicyclohexylamine, di-sec-butylamine, di-tert-butylamine, 1,1,1,3,3,3-hexamethyldisilazane, N-methyl-1,1,1,3,3,3-hexamethyldisilazane, N-ethyl-1,1,1,3,3,3-hexamethyldisilazane, 2,6-dimethylpiperidine, N-methyl-2,6-dimethylpiperidine, N-ethyl-2,6-dimethylpiperidine, 7-azabicyclo[2.2.1]heptane, N-ethyl azabicyclo[2.2.1]heptane, 1-azabicyclo[2.2.2]octane and combinations thereof.

12. The process as claimed in claim 10, wherein the radically polymerizable compound is selected from the group consisting of a styrene monomer, an acrylic monomer, a methacrylic monomer, and combinations thereof.

13. The process as claimed in claim 10, wherein the alkene compound is selected from the group consisting of decene, octene, allyltrimethylsilane, tert-butyl vinyl ether, 4-bromo-1-butene, vinyltrimethoxysilane and vinyltriethoxysilane.

14. The process as claimed in claim 10, wherein the borane BH₃-amine complex and the alkene compound are added with a molar ratio of from 1:1 to 1:20.

15. The process as claimed in claim 10, wherein the radically polymerizable compound has a content by mass of from 10% to 99%.

16. The process as claimed in claim 10, said process being carried out in the absence of agents for decomplexing the borane and the amine.

17. The process as claimed in claim 10, further comprising a heating step after bringing the borane BH₃-amine complex into contact with the alkene compound.

18. The process as claimed in claim 17, wherein the heating step is carried out at a temperature of from 20 to 60° C.

19. The process as claimed in claim 10, further comprising a heating step after bringing the reaction medium into contact with the composition comprising at least one polymerizable compound.

20. The process as claimed in claim 19, wherein the heating step is carried out at a temperature of from 20 to 100° C.
